(19) United States
(12) Patent Application Publication
(10) Pub. No.: US 2021/0362260 A1
(43) Pub. Date: Nov. 25, 2021

(54) APPARATUS AND METHOD FOR ORBITAL WELDING

(71) Applicant: CRC-EVANS PIPELINE INTERNATIONAL, INC., Houston, TX (US)

(72) Inventors: Timothy J. BOND, Cypress, TX (US); Mark CLEMMONS, Houston, TX (US); Alan JONES, Bellaire, TX (US); Nathan LYNCH, Houston, TX (US); Shailesh RADHAKRISHNAN, The Woodlands, TX (US)

(21) Appl. No.: 17/220,312

(22) Filed: Apr. 1, 2021

Related U.S. Application Data
(60) Provisional application No. 62/704,732, filed on May 26, 2020.
(60) Provisional application No. 62/704,656, filed on May 20, 2020.

(51) Int. Cl. B23K 9/095; B23K 9/00; B23K 9/028; B23K 9/32

(52) U.S. Cl. CPC B23K 9/0953; B23K 9/0052; B23K 2101/10; B23K 9/321; B23K 9/0286

(57) ABSTRACT

An orbital welder for welding together two pipes to be welded. The welder includes a fall brake for preventing a freefall of the welder. The welder includes a spatter shield for preventing dust from entering the outer housing and fowling sensitive machine components. The welder includes a torch assembly with manual adjustments. The welder includes an automatic lead/lag adjustment and control of that adjustment during a welding operation to automatically transition from a first weld zone to a second weld zone.

### CROSS-REFERENCE TO RELATED CASES

This non-provisional application claims the benefit of U.S. provisional application 62/704,732 filed May 26, 2020 and U.S. provisional application 62/704,656 filed May 20, 2020. Both applications disclose orbital welding machines with features that may be interchangeable. Furthermore, the disclosures of both U.S. Provisional Application No. 62/704,732 and U.S. Provisional Application No. 62/704,656 are incorporated herein by reference in their entirety.

### BACKGROUND OF THE INVENTION

The present invention relates to an apparatus and method of welding two pipe segments together. The prior art of FIG. 1 taken from U.S. Pat. No. 5,227,601 shows an orbital welder 5 connected to a first pipe 10 which is to be welded to a second pipe 12 at weld 14. Pipes 10 and 12 are aligned along a longitudinal axis a so that orbital welder 5 rotates about pipe axis a and about pipes 10 and 12. The orbital connection between orbital welder 5 and pipe 10 is via a track 24 which is strapped around pipe 10. A wheeled, grooved guide (not shown) on a lower side of orbital welder 5 traps track 24 thereto and guides orbital welder 5 around track 24 and around pipes 10 and 12.

FIG. 2 shows orbital welder 5 from a side view with torch C able to automatically pivot about an axis parallel to longitudinal axis a and in and out of the page to traverse weld W. FIG. 3 shows a view of orbital welder 5 looking longitudinally down the pipe and showing multiple pivot configurations in solid and shadow. FIG. 3 shows a bracket 56 in which torch C is pivotally secured.

Orbital welders such as the welder 5 shown in FIGS. 1A, 1B, and 1C are well known in the welding industry. However, cleaver and beneficial improvements may be combined with such conventional machines. For example, orbital welders 5 may be relatively heavy. This heavy welding machine 5 travels around the pipe 10 on a track in engagement with an automatically controlled motorized drive wheel. Therefore, when gravity urges welder 5 downward, the downward motion is resisted by the control system and speed control machinery. On the other hand, if the drive wheel is damaged and cannot make sufficient friction contact with track 24, the heavy machine may fall around track 24 out of normal control. It would be beneficial to add a feature which prevents welder 5 from uncontrollably rolling around the pipe and crashing in the event that drive wheel engagement is compromised.

At some time during operation of welder 5, an operator may desire to mount welder 5 onto track 24, remove welder 5 from track 24, or reposition welder 5 along track 24. That means the operator may choose to release the controlled engagement (e.g., by manipulating a lever or other mechanism) that prevents welder 5 from falling quickly due to gravity. It would therefore be beneficial to have a feature on the lever that prevented the operator from unintentionally releasing the engagement that allows travel. In other words, it would be beneficial to add a feature that the operator had to perform before the engagement could be released by the lever to ensure that when the engagement was released, the operator was ready and in position to handle the free weight of welder 5.

The welder 5 also includes a housing for containing the manipulation assembly which includes the mechanisms (e.g, gears and motors) responsible for automatically controlling the motions of the torch in its various degrees of freedom. A torch mount extends from the inside of the housing (at the manipulation assembly) to the outside of the housing is a slot. The torch mount travels within and along the slot. The weld operation will be located just outside the slot and would normally allow weld splatter to enter through the slot and potentially fowl mechanisms in the manipulation assembly. It would be beneficial to include a feature that covers the slot while allowing the torch mount to travel as necessary along the slot.

The manipulation assembly in the welder housing has the potential to automatically manipulate the torch along multiple degrees of freedom. However, it would be beneficial to also connect the manipulation assembly to a manual torch mount assembly so that in addition to the automatic manipulation capability, an operator could manually adjust (e.g., gross adjustment as opposed to the fine adjustment the manipulation assembly will perform) the torch in at least the degrees of freedom in which the manipulation assembly also operates.

A full weld pass in a typical pipeline weld is generally circular and that circle lies in a plane defined by that circular weld where the circle falls within the plane. One of the degrees of freedom in which the torch is manipulated is a pivot of the torch in the plane of the weld. FIG. 1C shows a torch being moved between two different configurations in the plane of the weld. In other words, as the welder 5 traverses the pipe, it is sometimes necessary to change the pivot angle of the torch in the plane of the weld. For example, the weld puddle may behave differently (e.g., less or more of a tendency to undesirably flow due to gravity) if the torch is in one angle configuration (e.g., compared to the opposite configuration mirrored along a radial line through the pipe longitudinal axis) rather than another. Because of this different behavior (e.g., at 3 and 6 o'clock looking down the pipe), and because an operator might desire to shift the torch angle without stopping the welding operation, it would be beneficial to automate the pivot angle in the plane of the weld as described above. Furthermore, it would be beneficial to provide an electronic control system that would direct the manipulation assembly to adjust the angle of the torch in the plane of the weld (e.g., adjust from a first angle to a second angle mirrored around a radial line through the torch tip and the longitudinal axis of the pipe) while maintaining the tip of the torch essentially in the same position it would have been in if the manipulation had not been happening. Specifically, it would be beneficial that the electronic computer control system controls the speed of welder 5 and the speed of the torch pivot to ensure that as the torch transitions between desired torch angles in the plane of the weld, that the tip of torch remains in a position to maintain the desired weld puddle heat. The lead/lag angle of the weld torch (i.e., angle in the plane of the weld) is automated and programmable by welding zone. Welding zone may related to the challenges of welding at different circumferential positions of the pipe due to gravity. As the bug travels around the pipe an onboard inclinometer may determine the clock position of the welding torch to enable the lead/lag angle of the torch to be automatically controlled to prevent weld defects.

### SUMMARY OF THE INVENTION

According to one aspect of the present invention, an orbital welder is disclosed which is for automatically rotating around two pipe ends to be welded together. The orbital welder is rollably connected to a track fastened around one of the pipe ends, the orbital welder includes a torch assembly including at least one weld torch. The orbital welder also includes a wire supply for housing wire to be fed to the weld torch. Furthermore, the orbital welder includes a manipulator assembly. The manipulator assembly including a manipulator housing and the manipulator housing includes a plurality of actuators for manipulating a position of the weld torch by manipulating the weld torch assembly. The orbital welder also includes a travel assembly which includes at least one actuator for actuating a drive wheel. The drive wheel is engageable with the track to propel the orbital welder around the pipe ends and an electronic computer controller controls the actuators to orient the torch assembly along a plurality of degrees of freedom during a weld operation. A desired weld operation requires a particular torch tip position relative to a weld puddle of the weld and a lead/lag pivot angle of the torch is automatically controlled by the electronic computer controller and adjusted during a weld operation in a weld sequence to maintain the torch tip position at the desirable position.

### BRIEF DESCRIPTION OF THE DRAWINGS

FIG. 1A shows a prior art automatic orbital welder of the present invention mounted to pipe segments to be welded.

FIG. 1B show a side view of the prior art automatic orbital welder of FIG. 1.

FIG. 1C shows the prior art automatic orbital welder of FIG. 1 looking along a longitudinal axis of the pipe segments.

FIG. 2A shows a top perspective view of an orbital welder of the present invention connected to a track fastened to a pipe segment to be welded.

FIG. 2B shows a second top and side perspective view of the orbital welder of FIG. 2A connected to a track fastened to a pipe segment to be welded.

FIG. 3 shows a top side view of a torch assembly of the welder of FIG. 2A.

FIG. 4 shows a top front view of the torch assembly of FIG. 3.

FIG. 5A shows a front perspective view of a housing of the welder of FIG. 2A.

FIG. 5B shows rear perspective view of the partial housing shown in FIG. 5A with a splatter shield in a first configuration.

FIG. 5C shows rear perspective view of the partial housing shown in FIG. 5A with a splatter shield in a second configuration.

FIG. 6A shows a cover plate and a portion of the splatter shield of FIGS. 5A and 5B extending through a slot therein.

FIGS. 6B, 6C and 6D show a rear view of the cover plate of FIG. 6A with the splatter shield in various configurations.

FIG. 7A shows a rear view of the welder partial housing of FIG. 5A and showing elements of an automatic torch manipulation assembly.

FIG. 7B shows a linear actuation subassembly of the manipulation assembly of FIG. 7A.

FIG. 8 shows an exploded view of the housing of FIGS. 2A and 2B.

FIG. 9A illustrates a lower perspective view of a portion the welder of FIG. 2A showing a handle and latching mechanism.

FIG. 9B illustrates a top perspective cut away view of a portion of the welder FIG. 2A showing internal elements of a biasing and cushioning latch.

FIG. 10A shows a lower perspective view of the partial housing of FIGS. 9A and 9B and showing a backup lock assembly.

FIGS. 10B and 10C show a backup lock assembly for securing the welder to the track if the drive wheel fails.

### DETAILED DESCRIPTION OF THE PREFERRED EMBODIMENTS

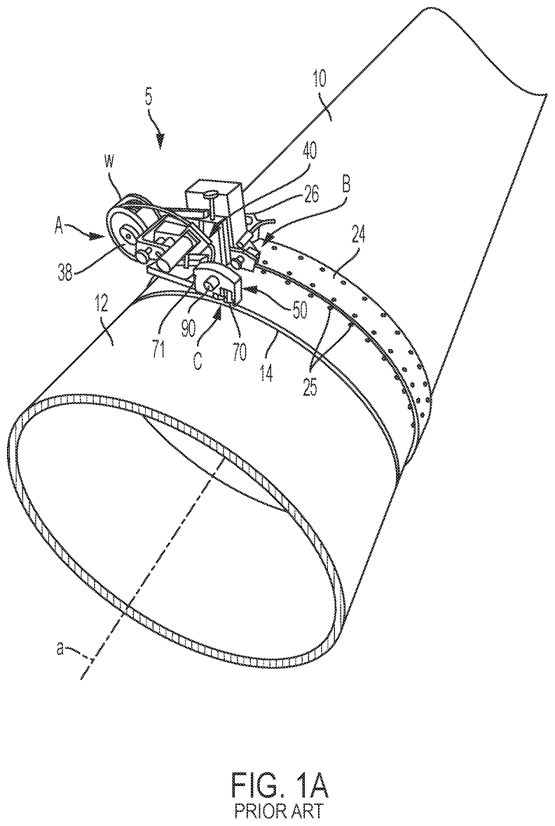

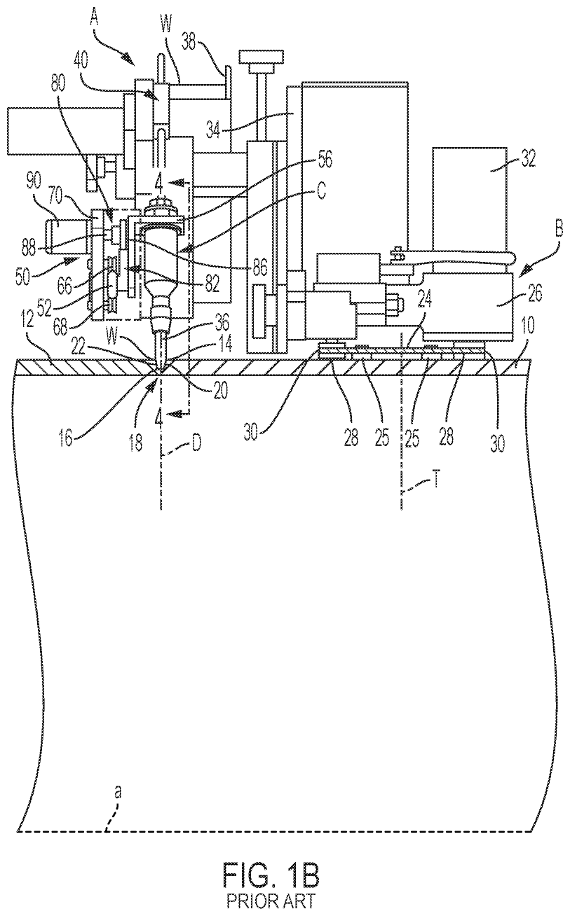

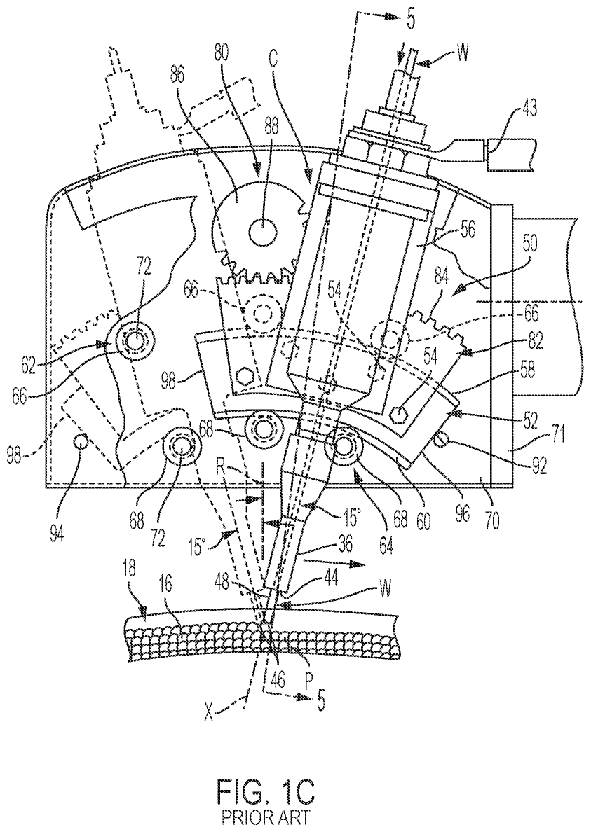

Conventional automatic orbital welders 5 as shown in FIG. 1 are widely employed to quickly and effectively weld two (e.g., 10 and 12) segments of a pipeline together. When a first segment 10 is to be welded to a second segment 12, a track 24 may be strapped around first pipe segment 10. A wheeled and/or geared connection (not shown) on the bottom of welder 5 may be attached to track 24 so as to guide welder 5 in an orbital path around pipe 10. That travel may be motorized and facilitated by gears on the wheeled geared connection which engage gears on track 24. The rollable attachment between welder 5 and track 24 may be any kind that rollably traps wheels onto welder 5 via track 24.

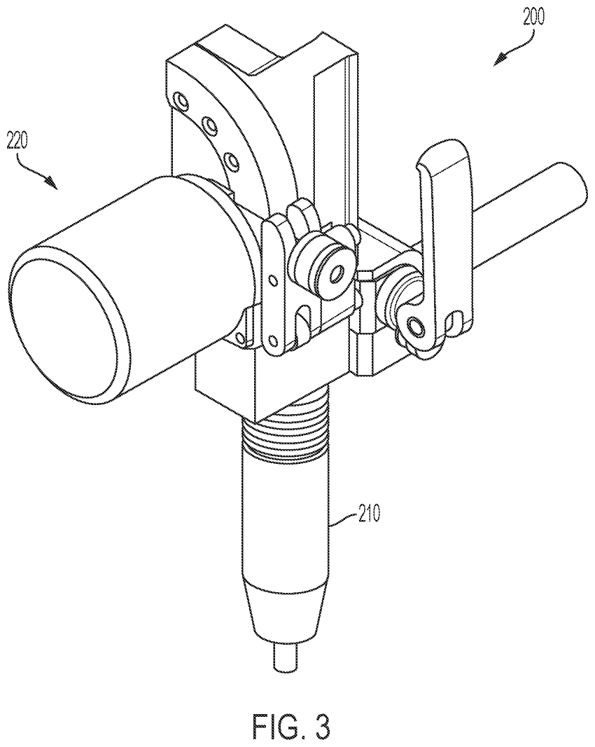

After welder 5 is connected to track 24, torch C of welder 5 is positioned generally over weld gap 14. Welder 5 can then automatically traverse track 24 to perform an automatic welding process in a 360° rotation around the pipe 10. In addition to automatic movement around pipe 10, welder 5 is able to pivot torch C in multiple degrees of freedom relative to weld gap 14 in order to build a desired weld. For example, welder 5 may provide automatic motorized pivoting of torch C in a plane of the circular weld perpendicular to a longitudinal axis a of pipe segments 10 and 12 as shown in FIG. 3. Welder 5 may also provide for pivotal or linear movements in other degrees of freedom such as back and forth in the width of weld gap 14 parallel to the longitudinal axis a.

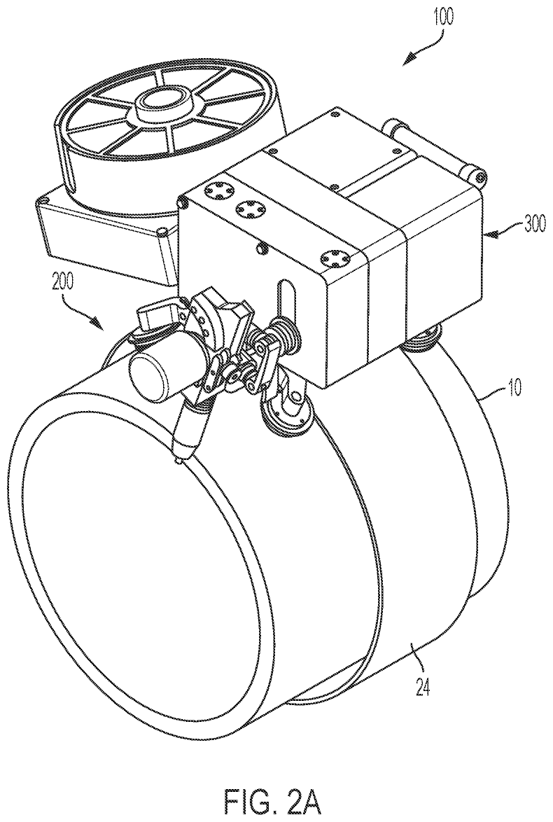

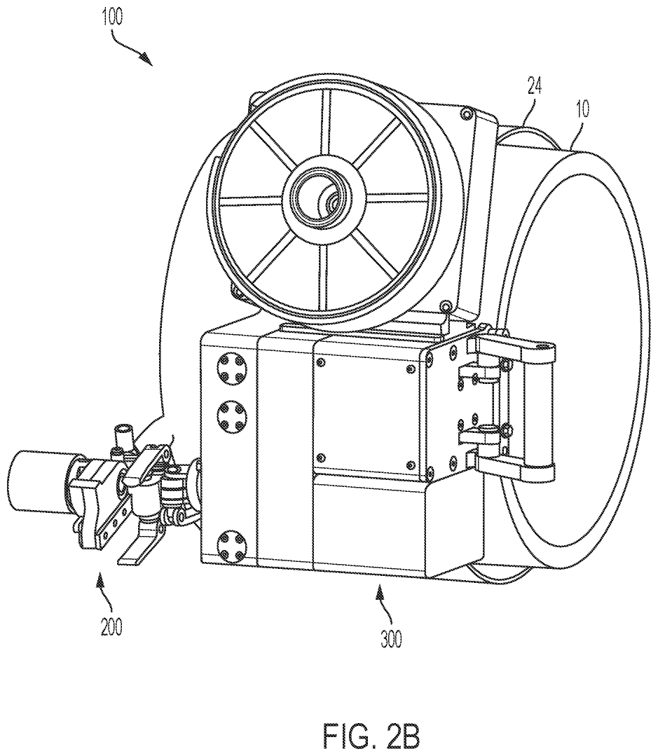

FIGS. 2A and 2B show an orbital welder 100 of the present invention secured to a track 24 strapped and to a pipe 10 to be welded.

FIG. 3 shows a perspective view of a torch assembly 200 of the present invention. Orbital welder 5 includes a housing 300 and a torch assembly 200. Torch assembly 200 includes a wire feeder 220 thereon. Wire feeder 220 includes a motor (not shown). An electronic computer controller controls feeder 220 and uses power from the motor to urge wire at a controlled rate toward or to the torch 210. Wire feeder is 220 is in proximity to or adjacent to the torch. Conventional wire feeders are distant from the torch and feed wire through channels. In conventional feeders, the distance between the feeder and the torch coupled with the behavior of the wire which can be made of different metals depending on the application makes it difficult feeding wire to the torch precisely. Furthermore, the engagement of the wire at feeder 20 right before the torch more consistently, precisely, and accurately delivers a desired shape/form (e.g., bending shape) of the wire to the torch. The present invention design eliminates the need for Bowden tube (and the problems associated with a Bowden tuge) since the wire is fed directly into the nozzle. It also eliminates the relative movement between the wire drive rollers and the welding nozzle that would otherwise occur when the nozzle is manipulated by the distant actuators. Furthermore, the present design reduces the power required by the wire drive since there is no Bowden tube to push through. Finally, the present design helps to maintain a consistent wire cast across a variety of wire sizes and types regardless of nozzle position.

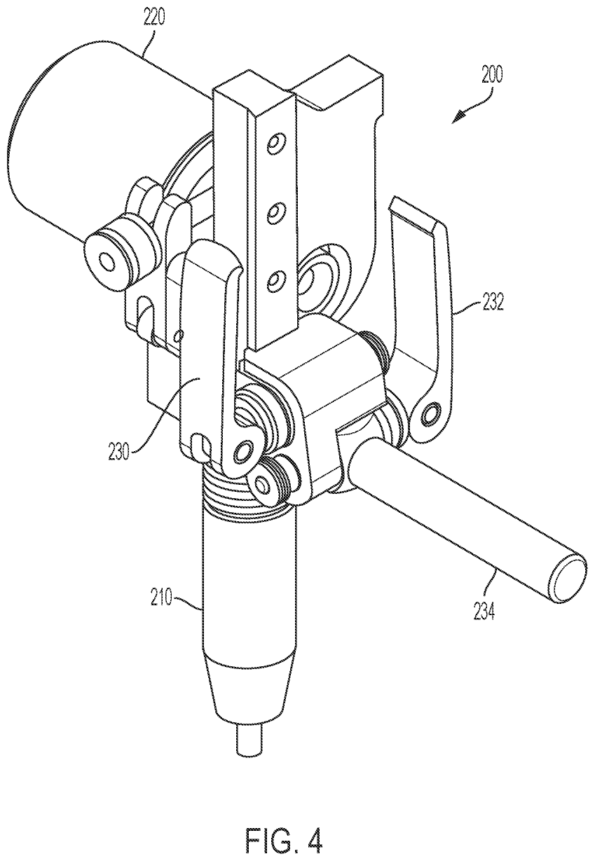

FIG. 4 shows the torch assembly of FIG. 3 from a different view that presents multiple levers. As discussed above in the Background, the entire torch assembly as shown in FIG. 3 and FIG. 4 is manipulated by an automatic manipulator assembly 330 discussed in greater detail below. However, at times an operator may desire to manually adjust the torch in at least the degrees of freedom controlled by the assembly 330. For example, an operator may observe that a tip of torch 210 is too close to a gap wall. In that case, the operator may manually use lever 232 to adjust travel limits of the torch tip in the longitudinal direction of the pipe (i.e., the oscillation direction in the width of the weld gap). Similarly, lever 230 can be used by the operator to manually adjust the radial distance from a central longitudinal axis of the pipe. Furthermore, lever 234 which swings in a horizontal plane can be adjusted to manually adjust the end or terminal limits of the torch pivot degree of freedom in the plane of the weld (See FIG. 1C).

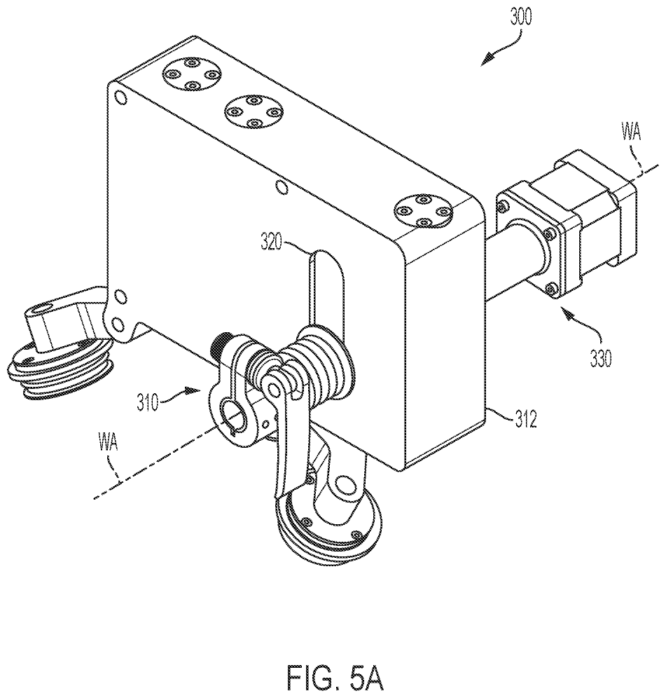

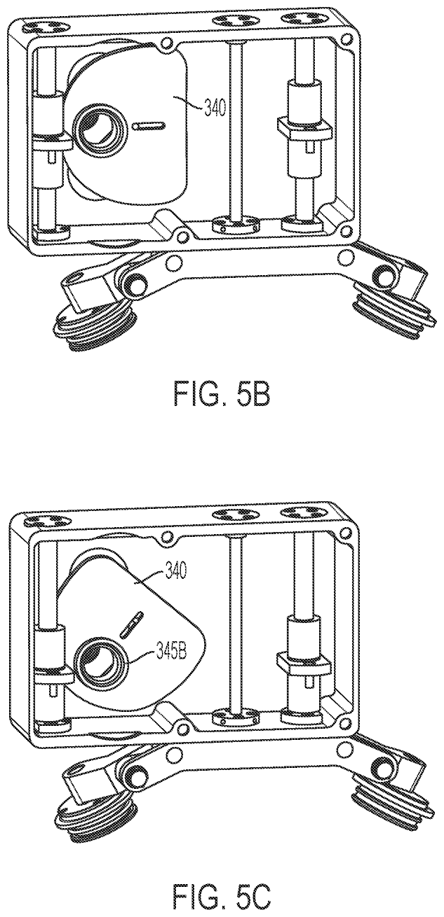

FIG. 5A shows a partial assembly of housing 300 of welder 100. A front face of housing 312 includes a elongate slot 320. A mount 310 extends from slot 320. Mount 310 is for mounting torch assembly 200 thereon. Manipulator assembly 330 to be discussed in greater detail below is able to automatically move mount 310 up and down in slot 320 (i.e., radially toward and away from a pipe longitudinal axis), axially in and out linearly along axis WA as shown in FIG. 5A, and rotationally about axis WA.

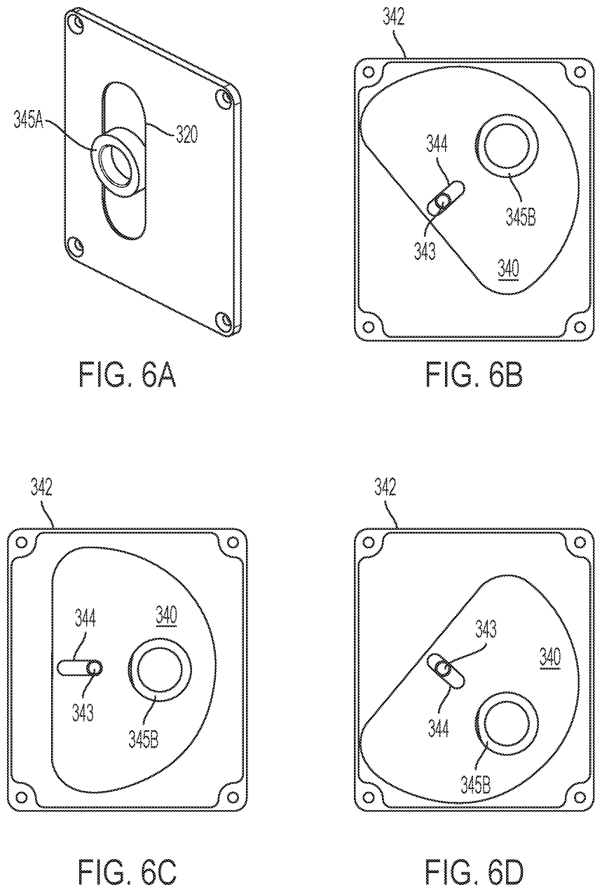

Because torch assembly 200 gets mounted to mount 310 which is so close to slot 320, weld splatter from torch 210 could potentially and undesirably enter slot 320. To prevent such entry and entry of other dirt and grit, the present invention employs a splatter shield that covers slot 320. Therefore, mount 310 is able to move back and forth within slot 320 which requires the slot to be open while a separate mechanism moves to block potential splatter when the slot needs to be closed. Furthermore, the shield mechanism is a single non-deforming member that moves to block the slot 320 while staying within the bounds of enclosure or housing 312. Specifically, FIG. 5B, FIG. 5C, and FIGS. 6A-6D show the splatter shield mechanism. FIG. 5B and FIG. 5C two configurations of a splatter shield 340. Splatter shield 340 includes a mount passage 345 (including 345A and 345B) such that passage 345B is exposed to the inside of housing 312 and passage 345A is exposed to the outside of housing 312. FIGS. 6A-6D show a shield plate 342 which defines the movement of shield plate 340. Specifically, splatter shield 340 includes a slot 344 and shield plate 342 includes a pin 343. Movement of splatter shield 340 is constrained as its slot 344 moves over pin 343. Furthermore, as shown in FIG. 6A, movement of mount passage 345A is constrained by slot 320. As such, splatter plate 340 is able to take the configurations shown in FIGS. 5 and 6. Those configurations maintain splatter shield 340 in a configuration where splatter shield 340 would block any splatter that might pass through slot 320 to manipulation assembly 330. Those configurations also allow mount passage 345 to move up and down in slot 320 freely.

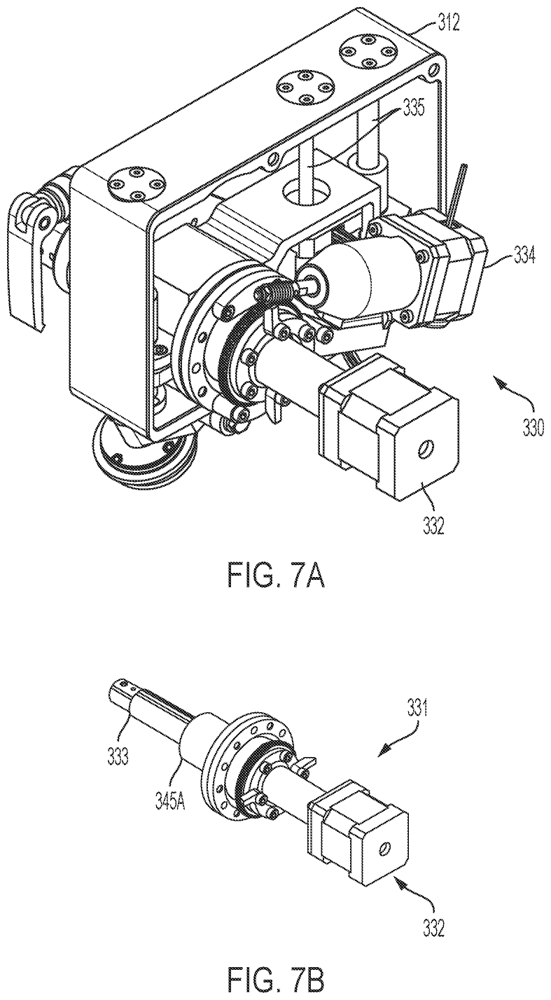

FIG. 7A shows a rear perspective view of housing 312 with a portion of housing 300 removed to reveal aspects of manipulation assembly 330. FIG. 7B shows a subassembly 331 of manipulation assembly 330. Sub assembly 331 includes a linear actuator 332 and a torch mount shaft 333. Torch mount shaft 333 passes through an opening in mount passage 345. Torch mount 310 can then be mounted to torch mount shaft 333. Torch assembly 200 can then be mounted to torch mount 310.

As discussed above, torch mount shaft 333 can move axially along axis WA, can rotate about axis WA, and can move up and down in slot 320. Specifically, a linear actuator 332 moves torch mount shaft 333 back and forth along axis WA. Motor 334 is fitted with a worm gear which engages a gear (e.g., a rotary bearing element) on oscillator subassembly 331 so that when motor 334 is actuated, the entire subassembly 331 rotates which rotates torch mount shaft 333 about axis WA. The entire oscillator sub-assembly rotates up to =/−90 deg from normal. This mechanism also allows for a tilt of the torch to a convenient position to perform quick maintenance such as tip change out. The worm drive mechanism provides a high gear ratio and prevents back drive. In addition, both subassembly 331 and the assembly containing motor 334 are connected together and are able to travel up and down along poles 335. Specifically a motor with a threaded trapped nut (not shown) move the double assembly up and down along poles 335 with the motor moving with the assembly.

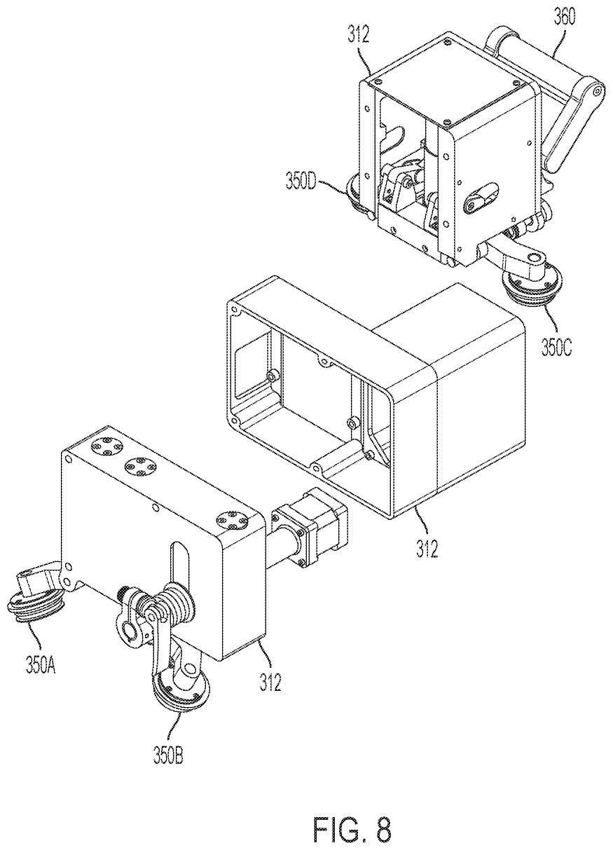

FIG. 8 shows an exploded view of housing 300. In order to make orbital welder 100 as compact as possible, the various parts of the systems are spatially overlap one another and the housings are shared. Therefore, a portion of the wheel carriage and manipulator assembly are contained in the same sub-housing. Similarly, a portion of the latching mechanism and the wheel carriage are contained in the same sub-housing.

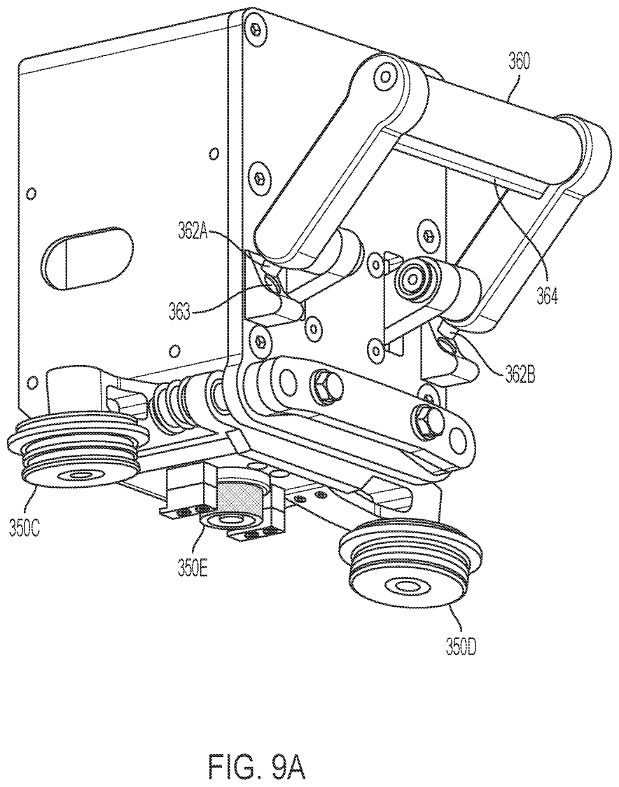

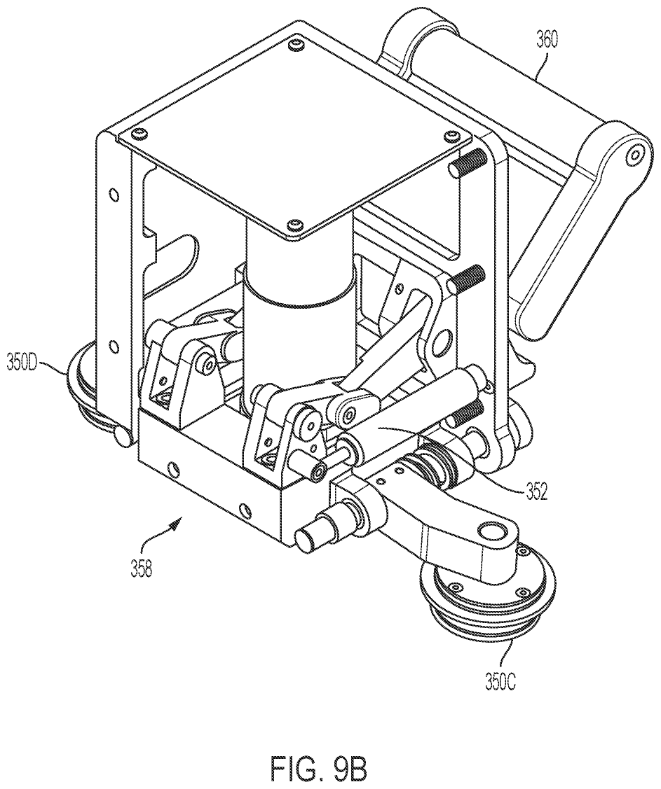

FIGS. 9A and 9B show a sub-assembly with a sub-housing that houses the wheel assembly and the latching mechanism for securing orbital welder 100 to track 24. As discussed above, because orbital welder 100 can be heavy, it would be beneficial to make sure an operator intends for lever 360 to be released whenever it is released. As an added assurance of an operator's intension, lever 360 includes a stop 362A such as a catch pin that prevents lever 360 from being actuated unless such actuation is really the intention of the operator. The catch pin 362 automatically engages into the catch pin receiver 363 and is released by squeezing a handle lever 364. A spring mechanism (to be discussed in greater detail below) is positioned mechanically between lever 360 and wheels 350A, 350B, 350C, 350D, and 350E so that when lever 360 is actuated and locked into place, the spring biases track 24 between subsets of the wheels. Furthermore, the linking mechanism 358 between the lever 360 and the wheels 350A, 350B, 350C, 350D and 350E includes one or more shock absorbers for absorbing potential shock to the operator when lever 360 is released. Lever or latch 360 can also be a carry handle for orbital welder 100. Latching is achieved by pushing the handle toward pipe 10. The travel system of repositioning bug 100 along track 24 allows for a high speed jog function of up to 200 in/min to minimize the need for a more unpredictable freewheeling function to reposition bug 100.

FIGS. 8 and 9 also show wheels 350A, 350B, 350C, 350D. When orbital welder 100 is to be secured to a pipe 10 to be welded, it is positioned against pipe 10 so that wheels 350A, 350B, 350C, 350D are aligned with track 24. Lever 360 is then pulled to contract grooves in wheels 350 securely around an edge of track 24. The lever mechanism shown in FIG. 9B generates includes at a plurality of biasing elements which when the latch/lever 360 is actuated to the locked position, biasingly locks wheels 350 to track 24.

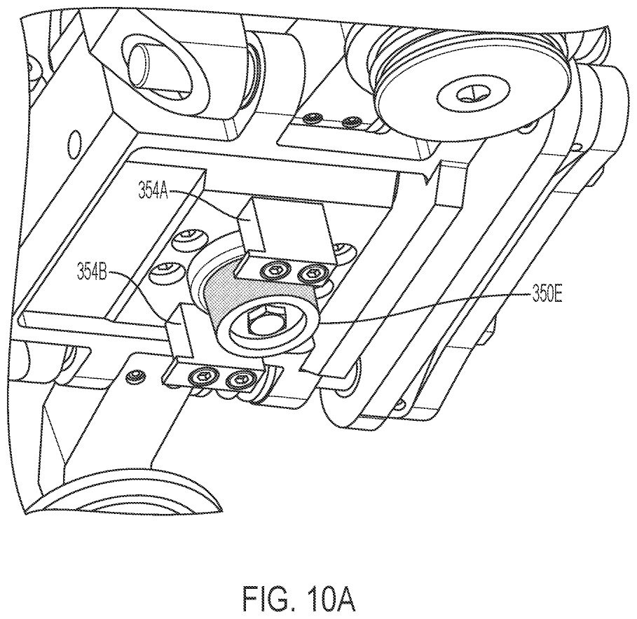

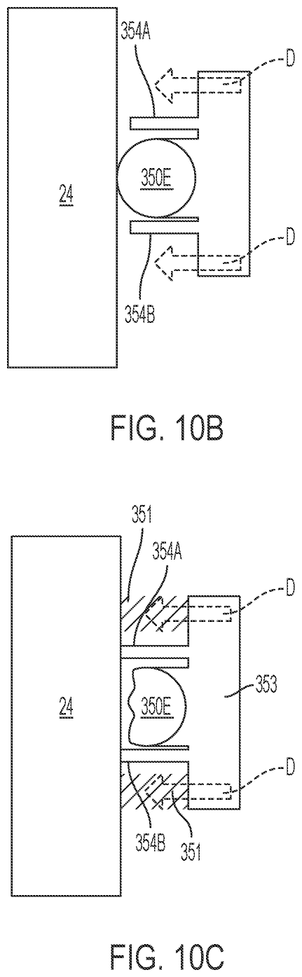

FIG. 10 shows a lower perspective view of a partial housing of welding housing 300. On the underside of welder 100 is drive wheel 350D. Drive wheel 350D is flanked by a plurality of backup engagement members 354A, 354B. FIGS. 10B and 10C show an arrangement that includes track 24. Normally, when drive wheel 350E functions as intended, the friction of the gear system that drives drive wheel 350E is enough to prevent a gravity freefall of a heavy orbital welder 100. However, should the wheel become damaged or inoperable, it would be beneficial to have a secondary or back up friction engagement to prevent a surprise falling of orbital welder 100. The present invention employs a plurality of friction blocks 354A, 354B for this purpose. When lever or latch member 360 is pulled and locked to bias wheels 350 against track 24, springs 351 bias drive wheel support 353 toward track 24. Drive wheel support 353 rollably supports drive wheel 350E. Friction blocks 354A, 354B are also mounted on drive wheel support 353. Therefore, when drive wheel support 353 is biased in direction D as shown in FIG. 10B, wheel 350 engages track 24 with sufficient friction to prevent an orbital welder 100 freefall. On the other hand, if (for whatever the reason) drive wheel 350D fails to transfer sufficient friction (e.g., drive wheel 350E brakes of derails), springs 351 will bias secondary of back up blocks 354 against track 24 (as shown in FIG. 10C) to prevent a freefall. Drive wheel failure could include a wheel crack, a wheel falling off, or a wheel just disappearing. The friction blocks 354A, 354B or fall arrest blocks also serve to prevent the bug from falling from the band in the event of the bug being installed incorrectly on the band i.e., the wheels engaging on the wrong groove. If incorrect installation has occurred the fall arrest block may prevent the bug 100 from travelling over the track 24 splice where the fall would otherwise occur. However, even if the bug does not somehow travel to the band splice, the fall arrest block may keep the bug attached to the band and prevent/discourage freefall.

The embodiments of the present disclosure described above are intended to be examples only. The present disclosure may be embodied in other specific forms. Alterations, modifications and variations to the disclosure may be made without departing from the intended scope of the present disclosure. While the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. Selected features from one or more of the above-described embodiments may be combined to create alternative embodiments not explicitly described. All values and sub-range s within disclosed ranges are also disclosed. The subject matter described herein intends to cover and embrace all suitable changes in technology. All references mentioned are hereby incorporated by reference in their entirety.

What is claimed is:

1. An orbital welder for automatically rotating around two pipe ends to be welded together, the orbital welder rollably connected to a track fastened around one of the pipe ends, the orbital welder comprising:
a torch assembly including at least one weld torch;
a wire supply for housing wire to be fed to the weld torch;
a manipulator assembly, the manipulator assembly including a manipulator housing, the manipulator housing including a plurality of actuators for manipulating a position of the weld torch by manipulating the weld torch assembly;
a travel assembly including at least one actuator for actuating a drive wheel, the drive wheel engageable with the track to propel the orbital welder around the pipe ends;
and an electronic computer controller for controlling the actuators to orient the torch assembly along a plurality degrees of freedom during a weld operation,
wherein a desired weld operation requires a particular torch tip position relative to a weld puddle of the weld and wherein a lead/lag pivot angle of the torch is automatically controlled by the electronic computer controller and adjusted during a weld operation in a weld sequence to maintain the torch tip position at the desirable position.

2. The orbital welder of claim 1, wherein a 360 deg travel rotation of the orbital welder is divided into a plurality of weld zones, the orbital welder traveling between weld zones during the weld sequence and the electronic computer controller adjusting the lead/lag angle as the torch tip passes from one weld zone to another.

3. The orbital welder of claim 2, wherein the location of a transition area between two zones is based on an expected change in how gravity will affect a weld puddle at a particular clock position around a weld.

4. The orbital welder of claim 2, wherein a reflection axis is defined by a line perpendicular to a central longitudinal axis of the pipes to be welded and passing through a torch tip, and wherein a central longitudinal axis of the torch passes the reflection axis as the torch transitions between two zones.

5. The orbital welder of claim 1, wherein the plurality of actuators incudes a lead/lag actuator which automatically rotates a portion of the manipulator assembly to change the lead/lag angle.

6. The orbital welder of claim 1, the electronic computer controller takes as input a signal from an inclinometer to determine a clock position of the torch in order to control a lead/lag angle of the weld torch.

7. The orbital welder of claim 1, wherein the electronic computer controller automatically changes a lead/lag angle to a maintenance angle in which the position of the torch tip is conveniently located for an operator to perform a maintenance function.

8. The orbital welder of claim 7, wherein in the maintenance angle, a torch tip is pivoted up away from the weld gap toward a position in which a central longitudinal axis of the weld torch is tangent to the pipe.

9. The orbital welder of claim 1, wherein the required torch tip position relative to the weld bead is required in order to maintain a predetermined operational weld puddle heat.

10. An orbital welder for automatically rotating around two pipe ends to be welded together, the orbital welder rollably connected to a track fastened around one of the pipe ends, the orbital welder comprising:
a torch assembly including at least one weld torch;
a wire supply for housing wire to be fed to the weld torch;
a manipulator assembly, the manipulator assembly including a manipulator housing, the manipulator housing including a plurality of actuators for manipulating a position of the weld torch by manipulating the weld torch assembly;
and an electronic computer controller for controlling the actuators to orient the torch assembly along a plurality degrees of freedom during a weld operation,
a travel assembly including a plurality of wheels for securing the orbital welder to the track, the plurality of wheels including a plurality of free rolling wheels and a powered drive wheel assembly, the powered drive wheel assembly including at least one actuator for actuating the powered drive wheel, the powered drive wheel engageable with the track to propel the orbital welder around the pipe ends;
a bias assembly including a latch and a biasing member, the biasing member disposed between the latch and the powered drive wheel assembly, and wherein
the travel assembly includes a first configuration in which the plurality of wheels are positioned wider than a width of the track and a second configuration in which the latch is actuated to bias the powered drive wheel and plurality of free rolling wheels against the track to rollablly lock the orbital welder to the track.

11. The orbital welder of claim 10, therein the bias assembly further includes at least one arrest member positioned such that in the second configuration the portion of the powered drive wheel in engagement with the track is between the track and the arrest block so that the arrest member is set back from the track with respect to the powered drive wheel along a longitudinal axis of the pipe.

12. The orbital welder of claim 11, wherein both the powered drive wheel and the at least one arrest member are biased toward the track such that if the powered drive wheel is damaged or can no longer holds its position, the at least one arrest block will approach and eventually become biased against the track.

13. The orbital welder of claim 10, wherein the biasing assembly further includes a shock absorber between the latch and a housing of the travel assembly to limit a shock of energy from the biasing member to an operator from the latch when the latch is moved from the second configuration to the first configuration.

14. The orbital welder of claim 10, wherein the latch includes a catch pin that prevents the latch from being moved between the first configuration and the second configuration unless a handle lever is also actuated.

15. An orbital welder for automatically rotating around two pipe ends to be welded together, the orbital welder rollably connected to a track fastened around one of the pipe ends, the orbital welder comprising:
a torch assembly including at least one weld torch;
a wire supply for housing wire to be fed to the weld torch;
a manipulator assembly, the manipulator assembly including a manipulator housing, the manipulator housing including a plurality of actuators for manipulating a position of the weld torch by manipulating the weld torch assembly;
a travel assembly including at least one actuator for actuating a drive wheel, the drive wheel engageable with the track to propel the orbital welder around the pipe ends;
and an electronic computer controller for controlling the actuators to orient the torch assembly along a plurality degrees of freedom during a weld operation,
wherein, the manipulator assembly includes a manipulator shaft which passes through a slot in the manipulator housing, the manipulator housing further including a splatter shield, the splatter shield pivoting to covering an open portion of the slot.

16. The combination of claim 15, wherein the pivot of the splatter shield is about an axis of the manipulator shaft.

17. The combination of claim 15, wherein the manipulator housing defines an inner space and the splatter shield is confined within the inner space.

18. The orbital welder of claim 15, wherein the splatter shield includes one of a slot and a pin and the manipulator housing includes the other of a slot and a pin and movement of the splatter shield is defined by movement of the pine within the slot.

19. The orbital welder of claim 2, wherein the weld sequence produces at least one complete 360 degree weld pass.

20. The orbital welder of claim 7, wherein the electronic computer controller places the torch in the maintenance angle during an operational weld sequence.
